(19) United States
(12) Patent Application Publication
(10) Pub. No.: US 2016/0335262 A1
(43) Pub. Date: Nov. 17, 2016

(54) DATA MANAGEMENT SYSTEM

(71) Applicant: PREDICTIVE SCIENCE L.L.C., AUSTIN, TX (US)

(72) Inventors: STEVEN TEDJAMULIA, AUSTIN, TX (US); NEAL CRAIG VARNER, LEHI, UT (US); RODNEY WHISNANT, AUSTIN, TX (US)

(21) Appl. No.: 14/709,217

(22) Filed: May 11, 2015

(51) Int. Cl. G06F 17/30

(52) U.S. Cl. CPC G06F 17/3053; G06F 17/30589

(57) ABSTRACT

According to an aspect of an embodiment, a method may include obtaining hierarchal data corresponding to a hierarchy associated with an organization. The method may further include obtaining designation data with respect to one or more target areas and one or more target metrics. Moreover, the method may include generating a data map based on the hierarchal data and the designation data. Additionally, the method may include generating one or more scoring formulas and one or more scores based on one or more of the following: the designation data and the hierarchal data. Furthermore, the method may include generating a digital user interface dashboard based on one or more of the following: the data map, the hierarchal data, and the designation data.

### FIELD

The embodiments discussed in the present disclosure are related to a data management system.

### BACKGROUND

Data may include metrics that may indicate states of target areas of organizations. However, the amount and diversity of the data may be such that analyzing and organizing the data to extract the metrics and assess the states of the target areas is often difficult.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include obtaining hierarchal data corresponding to a hierarchy associated with an organization. The hierarchal data may indicate a first node of the hierarchy, a second node of the hierarchy, and a first hierarchal relationship in the hierarchy between the first node and the second node in which the first node is an ancestor node of the second node in the hierarchy. The first node may correspond to a first target area of the organization and the second node may correspond to a second target area of the organization that is a subset of the first target area. The method may further include obtaining designation data. The designation data may include a data type that is designated for analysis with respect to the second target area and a target metric that is indicated by data of the data type and that is designated for analysis with respect to the second target area. Moreover, the method may include generating a data map based on the hierarchal data and the designation data. Additionally, the method may include generating a metric scoring formula for the target metric based on the designation data. The method may also include generating a second-node scoring formula that includes the metric scoring formula and that determines a second-node score for the second node. The second-node scoring formula may include the metric scoring formula based on the target metric being designated for analysis with respect to the second target area, as indicated by the designation data. The method may additionally include generating a first-node scoring formula that includes the second-node scoring formula and that generates a first-node score for the first node. The first-node scoring formula may include the second-node scoring formula based on the first hierarchal relationship, as indicated by the hierarchal data. Furthermore, the method may include generating a digital user interface dashboard based on one or more of the following: the data map, the hierarchal data, and the designation data. The digital user interface dashboard may be configured to present the second-node score in relation to the second target area as indicated by the data map, present the first-node score in relation to the first target area as indicated by the data map, and present the first-node score and the second-node score with respect to each other in a hierarchal manner according to the first hierarchal relationship.

The object and advantages of the embodiments will be realized and achieved at least by the elements, features, and combinations particularly pointed out in the claims. Both the foregoing general description and the following detailed description are given for explanatory purposes and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example operating environment of a data management system;

FIG. 2 illustrates an example digital user interface dashboard that may provide a visualization of node scores associated with an organization in a hierarchal manner;

FIG. 3 illustrates an example computing device; and

FIG. 4 illustrates an example method for managing data.

### DESCRIPTION OF EMBODIMENTS

Data may include metrics that may indicate states of target areas of an organization. The target areas may include the organization in general, departments, groups, sections, units, etc. (referred to generally as “organization units”) of the organization, employees of the organization, offices of the organization, campaigns of the organization, products of the organization, services of the organization, group members of the organization, contractors of the organization, goals of the organization, performance with respect to competitors, etc., or any other area corresponding to the organization whose state may be of interest to the organization.

In the present disclosure, a “state” of a target area, may refer to performance of the target area, health of the target area, realization of goals or objectives with respect to the target area, morale within the target area, positive or negative trends of the target area, public perception of the target area, any other suitable factor that may indicate a strength or weakness of the target area, or any combination thereof.

In some instances, the organization may generate, collect, or organize data that may include one or more metrics that may indicate states of the target areas. In the present disclosure, data that may be generated, collected, or organized by the organization may be referred to as “organization data.” Examples of organization data may include sales numbers, expenses, revenue, research and development advances, numbers of members of an organization or organization unit, realization of goals or objectives, or any other type of data that may be generated and collected by the organization and that may indicate metrics that may be used to assess states of the target areas.

Additionally or alternatively, data collected, generated, or organized by third-parties that are not associated with the organization (“third-party data”) may also include one or more metrics that may indicate the states of target areas of the organization. Examples of third-party data may include general industry data of an industry with which the organization may be involved, data related to competitors of the organization, data related to other organizations with similar structures as the organization, data related to organization units of other organizations that may be similar to the organization units of the organization, social-media data related to the organization or industry of the organization, social-media data related to campaigns of the organization, social-media data related to community efforts by the organization, blog data related to the organization, journalist data relating to the organization, reviews related to products or services of the organization, or any other data that may be collected or generated by third-parties that may indicate metrics that may be used to assess states of the target areas of the organization. In some embodiments, the organization data may include third-party data that may be collected or organized by the organization.

With the advent of the Internet and other computer-implemented data gathering technologies, the amount and diversity of organization data and third-party data that may include metrics that may indicate the states of target areas has increased dramatically. Additionally, the state of an individual target area may be based on different types of data, large amounts of data, or the states of one or more other target areas. The large diversity in the data and associated metrics, the large amount of data and associated metrics, and the interrelation between target areas may make it difficult to assess the state of the target areas.

For example, the state of a particular target area may be based on multiple metrics from a large range and amount of data that may be seemingly unrelated to each other. Therefore, assessing the state of the particular target area in a manner that factors in multiple metrics may be difficult because representing the metrics such that they may be combined to form an overall representation of the particular target area may be difficult. Additionally, changes in an individual metric of many metrics may affect the state of the particular target area. But, assessing which individual metric changed and how it affected the state of the particular target area may also be difficult. Further, some metrics may impact the state of the particular target area more than other metrics. Similarly, in some instances, the state of the particular target area may be based on one or more other target areas such that changes in one or more of the states of the other target areas (and their corresponding metrics) may affect the state of the particular target area and such that different target areas may affect the state of the particular target area differently.

The present disclosure includes systems and methods related to data management that may be used to organize (e.g., filter, sort, flag, etc.) data in a manner that improves the ability to represent a state of a target area. The present disclosure also includes systems and methods related to determining scores that may be used to represent the states of the target areas.

In particular, a data map may be generated to organize data in a manner for it to be used with area scoring formulas that may be determined for multiple target areas of the organization. The area scoring formulas may each generate a score that represents a state of the respective target area.

In some embodiments, the area scoring formulas may each include one or more metric scoring formulas that may be determined for each of one or more target metrics of the organization. The target metrics may include any metric that may be indicated by data and that may be designated for analysis by the organization with respect to one or more target areas of the organization. For example, the target metrics may include sales numbers, third-party reviews, social media responses, budgets, revenue, expenses, attendance reports, number of contacts, or any other applicable metric. In the present disclosure, the generic terms “scoring formula” and “scoring formulas” may be used to designate any combination of one or more area scoring formulas, metric scoring formulas, or any other type of scoring formula mentioned.

The scoring formulas and the data map may be configured such that multiple scoring formulas may be combined into a single scoring formula (“resultant scoring formula”). The resultant scoring formula may thus generate a score that may represent a state of a corresponding target area that may be based on a combination of the multiple target areas or the multiple target metrics that may correspond to the scoring formulas that may be included in the resultant scoring formula. Additionally or alternatively, the scoring formulas may be configured and generated to allow for target areas, target metrics, and data of varying types to be combined such that a corresponding state of a target area may be represented even with the presence of different data types, different target metrics, and different target areas.

As mentioned above, in some instances a particular target area may include the overall organization. Therefore, in some embodiments, the area scoring formula for the particular target area may include an overall scoring formula that includes all the scoring formulas may be generated. The overall scoring formula may thus indicate a general or overall state of the organization based on the different states of the multiple target areas and target metrics of the organization. Therefore, the data management described in the present disclosure may allow for assessing, from data of varying types, different states of target areas of the organization according to hierarchal and combinational relationships between target areas and target metrics.

Additionally, in some embodiments, the scores may be presented with respect to their respective target areas in a digital user interface dashboard. In these or other embodiments, the scores and their respective target areas may be represented in a hierarchal manner that may allow for viewing different levels of scores and target areas and that may indicate the hierarchal relationships between target areas. The determination and presentation of the scores according to the hierarchal relationships may thus provide a way for the organization to assess the state of a particular target area in a manner that also breaks down the assessment according to different target areas and target metrics that may affect the state of the particular target area. The systems and methods used for determination and presentation of the scores in the manner as described in the present disclosure may aid in assessing organizations by helping overcome difficulties associated with and caused by large amounts and different types of data as perpetrated, exacerbated, and exponentially increased by the use of computer-implemented or Internet-based data generation.

In the present disclosure, a hierarchy may include any suitable representation of elements where different elements may be categorized within different levels. Additionally or alternatively, the hierarchy may include any suitable representation where one or more elements may be included as sub-elements of another element.

In these or other embodiments, the hierarchy may include representations of hierarchal relationships within the hierarchy. Reference to a hierarchal relationship may refer to relationship between corresponding elements with respect to the hierarchy. Examples of hierarchal relationships referred to in the present disclosure may include ancestor/descendant relationships, parent/child relationships and sibling relationships.

An ancestor/descendant relationship may refer to a relationship where a state of a corresponding descendant element may affect a state of a corresponding ancestor element. Zero or one or more intermediate elements may be between the ancestor element and the descendant element where the state of the descendant element may also affect the states of the intermediate elements and where the states of the intermediate elements may also affect the state of the ancestor element.

A parent/child relationship may refer to a more specific type of an ancestor/descendant relationship. For example, a parent/child relationship may include an ancestor/descendant relationship that does not include any intermediate elements between a corresponding parent element and a corresponding child element. A sibling relationship may refer to a relationship between child elements that share a same parent element.

Embodiments of the present disclosure are explained with reference to the accompanying drawings.

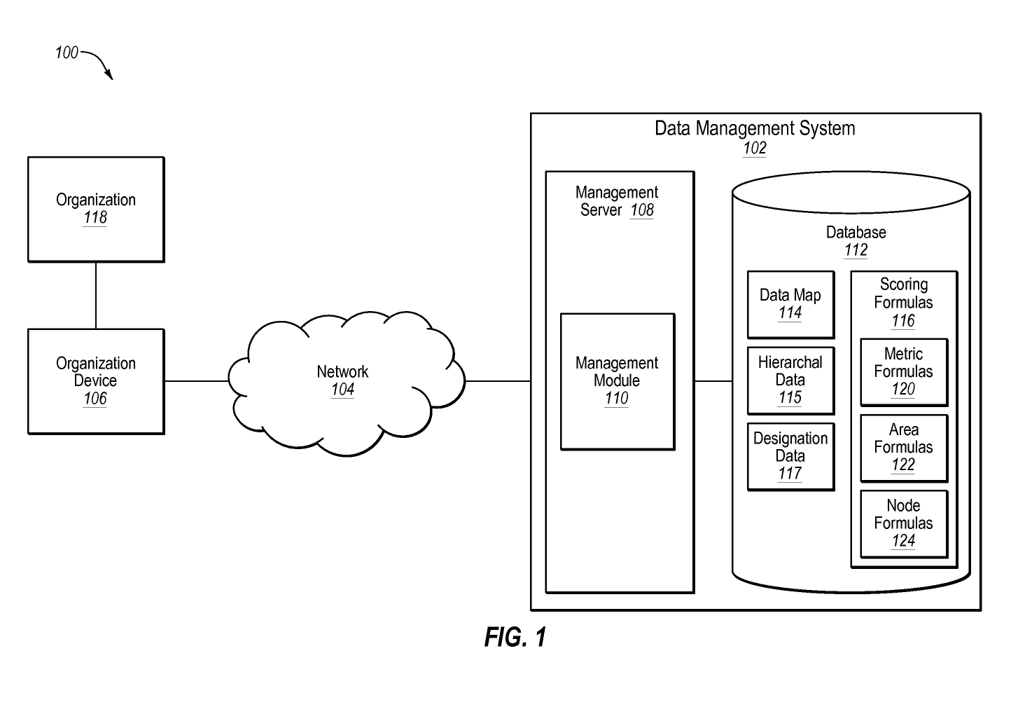

FIG. 1 is a diagram representing an example operating environment 100 (“environment 100”) of a data management system 102 (“system 102”), arranged in accordance with at least one embodiment described in the present disclosure. The environment 100 may also include a network 104, an organization device 106, and an organization 118.

The network 104 may include any interconnecting system capable of transmitting audio, video, signals, data, messages, or any combination of the preceding. For example, the network 104 may include all or a portion of a public switched telephone network (PSTN), a public or private data network, a local area network (LAN), a metropolitan area network (MAN), a wide area network (WAN), a cellular network, a local, regional, or global communication or computer network such as the Internet, a wireline or wireless network, an enterprise intranet, other suitable communication link, or any combination of the preceding.

One or more elements of the environment 100 may communicate with each other via the network 104. For example, in some embodiments, the organization device 106 and the system 102 may communicate data and information between each other via the network 104.

The organization device 106 may include any suitable electronic device that may be used by the organization 118 to view, obtain, generate, input, or otherwise access data or information. For example, the organization device 106 may include a desktop computer, a laptop computer, a tablet computer, a smartphone, a server, etc. In the present disclosure reference to the organization 118 may include reference to the organization 118 as a whole, organization units of the organization 118, or officers, employees, agents, etc. of the organization 118.

In some embodiments, the organization 118 may provide indications to the system 102, via the organization device 106 and the network 104, related to data or designations with respect to target areas, target metrics, data types, or data fields that may be used to assess a state of the organization 118. In particular, the indications may include indications of one or more target areas and/or one or more target metrics that may be designated for analysis with respect to the target areas. Further, the indications may include indications related to data types that may indicate the target metrics. Additionally or alternatively, the indications may include indications related to data fields of designated data types that may indicate the target metrics. In the present disclosure the term “data type” may include a data format (e.g., pdf, csv, etc), data derived from a particular program (e.g., an excel spreadsheet), data that indicates a certain type of information (e.g., sales data, revenue data, social media data, etc.), or any combination thereof.

By way of example, an indicated target area may include a specific marketing campaign of the organization and an indicated target metric may include a public sentiment of the marketing campaign as expressed in social media. A corresponding indicated data type may include social media data that may indicate the public sentiment. As another example, the indicated target area may include a sales department and the indicated target metric may include sales revenue of the sales department. The corresponding indicated data type may include sales data and corresponding data fields may include data fields of the sales data that may indicate the sales revenue.

In some embodiments, the organization 118 may also provide indications to the system 102 of a hierarchal relationship between target areas or target metrics. For example, the organization 118 may provide an indication of a first hierarchal relationship between a first target area and a second target area, in which the second target area may be included in and a subset of the first target area. Therefore, the first hierarchal relationship may indicate a parent/child hierarchal relationship between the first target area and the second target area. Additionally, as described in further detail below, the first hierarchal relationship may also indicate that a first state of the first target area may be based on a second state of the second target area.

As a further example, the organization 118 may provide an indication of a second hierarchal relationship between the second target area and a third target area in which the third target area is included in and thus a subset of the second target area. Therefore, the second hierarchal relationship may indicate a parent/child relationship between the second target area and the third target area. Additionally, the second hierarchal relationship and the first hierarchal relationship may together indicate an ancestor/descendant hierarchal relationship between the first target area and the third target area. As such, the second hierarchal relationship may indicate that the second state of the second target area may be based on a third state of the third target area. In addition, the second hierarchal relationship and the first hierarchal relationship may together indicate that the first state of the first target area may also be based on the third state of the third target area.

Additionally or alternatively, the organization 118 may provide an indication of a third hierarchal relationship between the first target area and a fourth target area in which the fourth target area is included in and thus a subset of the first target area, but not the second target area. Therefore, the third hierarchal relationship may indicate a parent/child hierarchal relationship between the first target area and the fourth target area in which the first target area may have a parent hierarchal relationship with respect to the fourth target area. Thus, the third hierarchal relationship may also indicate that the first state of the first target area may also be based on a fourth state of the fourth target area. In addition, the third hierarchal relationship and the fourth hierarchal relationship may together indicate a sibling hierarchal relationship between the second target area and the fourth target area.

As another example, the organization 118 may provide an indication that a particular target metric is designated for analysis with respect to a particular target area. Such an indication may thus indicate a particular hierarchal relationship between the particular target area and the particular target metric in which the particular target metric may have a child hierarchal relationship with respect to the particular target area. Additionally, an indication that the particular target metric is designated for analysis with respect to the particular target area may also indicate that another target area that has an ancestor hierarchal relationship with respect to the particular target area may also have an ancestor hierarchal relationship with respect to the particular target metric.

Although specific examples and numbers of hierarchal relationships are given such examples and numbers are not limiting. The organization 118 may provide indications of any number or type of hierarchal relationships associated with target areas or target metrics.

Additionally or alternatively, the organization 118 may provide indications related to weighing different target areas or target metrics with respect to a state of an ancestor target area. For example, the organization 118 may provide a first weight with respect to a first target metric that may be designated for analysis with respect to a particular target area. Additionally, the organization 118 may provide a second weight with respect to a second target metric that may also be designated for analysis with respect to the particular target area. As detailed below, the first and second weights may indicate how much weight to give the first target metric and the second target metric, respectively, in determining a state of the particular target area. For example, a first weight of “2” and a second weight of “1” may indicate that the first target metric factors into the state of the particular target area more than the second target metric. Weights for sibling target areas with respect to a parent or other ancestor target area may be indicated in a similar manner.

The organization 118 may also provide any other information to the system 102 that may be used to assess a state of the organization 118 with respect to one or more target areas or target metrics. For example, the organization 118 may provide organization data to the system 102 such that the system 102 may assess a state of the organization 118 with respect to one or more target areas or target metrics according to information that may be included in the organization data. As another example, the organization may provide information as to types of or how to obtain third-party data that may include target metrics.

The system 102 may include a management server 108, which may include a management module 110 in the illustrated example. The system 102 may also include a database 112, which may include stored thereon a data map 114, hierarchal data 115, designation data 117, and scoring formulas 116.

The management server 108 may include a hardware server that includes memory, data storage, and one or more processors. In some embodiments, the management server 108 may include network communication capabilities such that the management server 108 may communicate with the organization device 106 via the network 104.

The designation data 117 may include the indications related to designations by the organization 118 with respect to target areas, target metrics, or data types that may be used to assess states of the target areas of the organization 118. Additionally or alternatively, the designation data 117 may include the indicated weights that may be provided by the organization 118. In some embodiments, the management module 110 may be configured to obtain the designation data 117. The management module 110 may obtain the designation data 117 by generating the designation data 117 from the designations and weights that may be indicated by the organization 118. Additionally or alternatively, the management module 110 may obtain the designation data 117 by having it provided by the organization 118.

In these or other embodiments, the management module 110 may be configured to generate suggestions for the organization 118 as to what may be included in the designation data 117 and the organization 118 may select target areas, target metrics, data types, or data fields from the suggestions. For example, in some embodiments, the organization 118 may provide a designation of a particular data type for analysis. The management module 110 may be configured to analyze data of the particular data type to identify data fields of the data type that may indicate target metrics.

By way of example, numerical fields often include information that may indicate target metrics such that the management module 110 may be configured to search through the data of the particular data type for numerical fields. As another example, string-based fields often include information that may label data fields associated with target areas or target metrics that may be included in data such that the management module 110 may be configured to search through the data of the particular data type for string-based fields.

In response to identifying data fields that may indicate target metrics or target areas, the management module 110 may be configured to generate a list of the identified data fields. The management module 110 may be configured to provide the list of identified data fields to the organization 118 (e.g., via the network 104 and the organization device 106), which may allow the organization 118 to select one or more of the identified data fields for analysis. Additionally, the management module 110 may be configured to analyze the designated fields for potential target metrics and may provide suggestions to the organization 118 of the potential target metrics. The organization 118 may then select one or more of the potential target metrics as target metrics.

The hierarchal data 115 may include indications by the organization 118 related to the hierarchal relationships between the target areas or target metrics of the organization 118. For example, in some embodiments, the hierarchal data 115 may include a node for each of the target areas and target metrics. The hierarchal data 115 may also indicate hierarchal relationships between the nodes that may be based on the hierarchal relationships between the corresponding target areas or target metrics, which may be indicated by the organization 118.

In some embodiments, the management module 110 may be configured to obtain the hierarchal data 115. The management module 110 may obtain the hierarchal data 115 by generating the hierarchal data 115 from the hierarchal relationships that may be indicated by the organization 118. Additionally or alternatively, the management module 110 may obtain the hierarchal data 115 by having it provided by the organization 118.

In these or other embodiments, the management module 110 may be configured to generate suggestions for the organization 118 as to what may be included in the hierarchal data 115 and the organization 118 may indicate hierarchal relationships from the suggestions. For example, in some embodiments, the organization 118 may provide a designation of a particular data type for analysis. The management module 110 may be configured to analyze data of the particular data type to identify data fields of the particular data type that may indicate hierarchal relationships within the data. By way of example and as mentioned above, string-based fields often include information that may indicate target areas or target metrics. Additionally, the string-based fields may be organized in a hierarchal manner in the data, which may indicate hierarchal relationships between the target areas and/or target metrics.

For example, a particular string-based field in the data may be oriented or designated such that it may indicate that data in other data fields may be tied to a particular area labeled in the string-based field. Additionally, one or more of the data fields tied to the particular area may also include string-based fields that may indicate sub-areas of the particular area. The management module 110 may therefore be configured to identify a hierarchy of the data (“data hierarchy”) in which the sub-areas may have a descendant hierarchal relationship with respect to the particular area based on their respective data fields being included in a sublevel of the data hierarchy as compared to the level of the particular string-based field.

In response to identifying a data hierarchy, the management module 110 may generate a list of the identified hierarchal relationships that may be determined from the data hierarchy, which may be provided to the organization 118 (e.g., via the network 104 and the organization device 106). The organization 118 may then select one or more of the identified hierarchal relationships for inclusion in the hierarchal data 115.

In some embodiments, the management module 110 may be configured to generate the data map 114 and the scoring formulas 116 based on the designation data 117 and the hierarchal data 115. As described below, the data map 114 and the scoring formulas 116 may be configured based on the designation data 117 and the hierarchal data 115 such that a state of the organization 118 may be represented through analysis and manipulation of data according to the indicated information.

In some embodiments, the management module 110 may be configured to generate the data map 114 according to the target areas, target metrics, data types, or hierarchal relationships that may be included in the designation data 117 and the hierarchal data 115. By way of example, the management module 110 may determine, from the designation data 117, a particular data type or a particular data field designated for analysis with respect to a particular target area or target metric. The analysis module 110 may then configure the data map 114 such that the data map 114 may direct that data of the particular data type be flagged to indicate such designation. Therefore, the management module 110 may then flag the data accordingly when data of the particular data type or with the particular data field is received.

In particular, in some embodiments, the management module 110 may be configured to generate the data map 114 such that the data map 114 may indicate that data of the particular data type be tagged with respect to the particular target area or target metric such that the data may be accordingly tagged and filtered according to the tagging. In these or other embodiments, the particular data field may be tagged with an indicator that corresponds to the particular target area or target metric. In the present disclosure, reference to “tagging” data may include adding metadata to the data, including identifiers of the data in storage designations for corresponding target areas or target metrics, or any combination thereof.

Additionally or alternatively, the management module 110 may be configured to generate the data map 114 based on the designation data 117 such that the data map 114 may also direct analysis of data to facilitate or enable the organization of the data. For example, the data map 114 may direct that data of a particular data type be parsed for information (e.g., as indicated by the designation data 117) related to a particular target area (e.g., parsing of social media data for comments related to an ad campaign). In these or other embodiments, the management module 110 may be configured to generate the data map 114 such that the data map 114 may direct that the data of the particular data type with the information be tagged with respect to the particular target area (e.g., social media data with comments related to the ad campaign may be tagged with respect to the ad campaign).

The management module 110 may also be configured to generate the data map 114 according to the hierarchal data 115 in some embodiments. For example, the management module 110 may generate the data map 114 based on the hierarchal data 115 such that the data map 114 may direct the organization of data tagged with respect to different target areas or target metrics according to the hierarchal relationships between the different target areas or target metrics. By way of example, the management module 110 may be configured to generate the data map 114 such that particular data that may be tagged with respect to a particular target metric may also be tagged with respect to target areas that may have ancestor hierarchal relationships with the particular target metric, as indicated by the hierarchal data 115.

Further, in some embodiments, the data map 114 may include the hierarchal data 115 and the designation data 117. Therefore, the data map 114 may also include general indications with respect to a framework of representing states of the target areas.

The scoring formulas 116 may include one or more metric scoring formulas 120 and one or more area scoring formulas 122. The metric scoring formulas 120 may each be configured to generate a metric score for an associated target metric that may indicate a state of a target area with respect to the associated target metric. The area scoring formulas 122 may each be configured to generate an area score for an associated target area that may indicate a state the associated target area.

In some embodiments, the management module 110 may be configured to generate each of the metric scoring formulas 120 based on a corresponding target metric and an associated target data type that may be designated for analysis with respect to the corresponding target metric. As described in further detail below, in some embodiments, the metric scoring formulas 120 may be normalized. Additionally or alternatively, the normalization may be such that the values of the corresponding metric scores may be between “0” and “1.”

By way of example, a first target metric may include public sentiment and a corresponding first target data type for the first target metric may include social media data, such as Facebook® or Twitter® posts. The management module 110 may generate a sentiment scoring formula as a first metric scoring formula for the first target metric. The sentiment scoring formula may be configured to generate a sentiment score for a particular topic (e.g., a particular target area) based on the social media data. The sentiment scoring formula may also be normalized in some embodiments. For example, the sentiment scoring formula may include dividing a total number of positive mentions with respect to a particular topic by a total number of mentions with respect to the particular topic.

As another example, a second target metric may include social media volume and a corresponding second target data type for the second target metric may also include social media data, such as Facebook® or Twitter® posts. The management module 110 may generate a volume scoring formula as a second metric scoring formula for the second target metric. The volume scoring formula may generate a volume score for a particular topic (e.g., a particular target area) based on the social media data. The volume scoring formula may also be normalized in some embodiments. For example, the volume scoring formula may include dividing, by a target volume with respect to the particular topic, the lesser value of current volume with respect to the particular topic or the target volume with respect to the particular topic.

As another example, a third target metric may include sales revenue and a corresponding third target data type may include sales numbers data. The management module 110 may generate a revenue scoring formula as a third metric scoring formula for the third target metric. The revenue scoring formula may generate a revenue score based on the sales numbers data. The revenue scoring formula may also be normalized in some embodiments. For example, the revenue scoring formula may include dividing, by a target sales revenue, the lesser value of current sales revenue or the target sales revenue.

In some embodiments, the management module 110 may be configured to generate the area scoring formulas 122 based on the hierarchal data 115, the designation data 117, and the metric scoring formulas 120. For example, the management module 110 may be configured to include in each area scoring formula 122, the metric scoring formulas 120 of the target metrics that may be designated for analysis with respect to the corresponding target areas.

In some embodiments, (e.g., when only one target metric is designated for analysis with respect to a particular target area), the corresponding area scoring formula 122 of the particular target area may be substantially the same as the metric scoring formula for the target metric that is designated for analysis with respect to the particular target area. For example, the first target metric discussed above may be the only target metric designated for analysis with respect to a particular target area such that a particular area scoring formula 122 of the particular target area may be substantially the same as the first metric scoring formula.

As indicated above, in some embodiments, a particular area scoring formula 122 may include multiple metric scoring formulas 120. Additionally, as indicated above, the metric scoring formulas 120 may be normalized, which may allow for including multiple metric scoring formulas 120 with a particular area scoring formula 122. Additionally or alternatively, weights of the target metrics designated for analysis with respect to a particular target area may also be included in the particular area scoring formula 122.

For example, an area scoring formula 122 that may generate an area score “Aₛ” for a particular target area with “n” number of target metrics designated for analysis therewith may be represented as follows:

“Aₛ=M₁(w₁/s)+M₂(w₂/s)+ . . . Mₙ(wₙ/s)”

In the above expression, “M₁” may represent a first metric scoring formula of a first target metric designated for analysis with respect to the particular target area; “w₁” may represent a first weight of the first target metric with respect to the particular target area; “M₂” may represent a second metric scoring formula of a second target metric designated for analysis with respect to the particular target area; “w₂” may represent a second weight of the second target metric with respect to the particular target area; and so forth until reaching the nth target metric in which “Mₙ” may represent an nth metric scoring formula of an nth target metric designated for analysis with respect to the particular target area and “wₙ” may represent an nth weight of the nth target metric with respect to the particular target area. Additionally, in the above expression “s” may represent the sum of the weights “w.”

The area scores may indicate the states of their respective target areas. As such, the inclusion of multiple metric scoring formulas in a particular area scoring formula may provide that the resultant area score may also represent the state of a particular target area as a combination of the multiple target metrics designated for analysis with respect to the particular target area.

Additionally, an area scoring formula 122 for a target area with an ancestor hierarchal relationship (referred to as an “ancestor target area”) with respect to one or more other target areas (referred to as “descendant target areas”), as indicated by the hierarchal data 115, may include the area scoring formulas 122 of its descendant target areas. The area scoring formula 122 for the ancestor target area (“ancestor scoring formula”) may thus also include the metric scoring formulas that may be included in the area scoring formulas of its descendant target areas (“descendant scoring formulas”).

For example, the hierarchal data 115 may indicate that a first target area has a parent hierarchal relationship with respect to a second target area and a third target area. Further, the hierarchal data 115 may indicate that the second target area has a parent hierarchal relationship with respect to a fourth target area. Further, a first target metric may be designated for analysis with respect to the fourth target area and a second target metric may be designated for analysis with respect to the third target area. As such, a first area scoring formula for the first target area may include a second area scoring formula for the second target area, which may include a fourth area scoring formula for the fourth target area, which may in turn include a first metric scoring formula for the first target metric. Additionally, the first area scoring formula may include a third area scoring formula for the third target area, which may include a second metric scoring formula for the second target metric.

Additionally or alternatively, weights of descendant target areas designated with respect to a particular ancestor target area may also be included in the area scoring formula 122 of the particular ancestor target area. For example, a parent area scoring formula that may generate an area score “A_{P}” for a particular parent target area with “n” number of child target areas may be represented as follows:

“A_{P}=A_{c1}(w_{c1}/s_{c})+A_{c2}(w_{c2}/s_{c})+ . . . A_{cn}(w_{cn}/s_{c})”

In the above expression, “A_{c1}” may represent a first area scoring formula of a first child target area of the particular parent target area; “w_{c1}” may represent a first weight of the first child target area with respect to the particular parent target area; “A_{c2}” may represent a second area scoring formula of a second child target area of the particular parent target area; “w_{c2}” may represent a second weight of the second child target area with respect to the particular parent target area; and so forth until reaching the nth child target area in which “A_{cn}” may represent an nth child area scoring formula of an nth child target area of the particular parent target area and “w_{cn}” may represent an nth weight of the nth child target area with respect to the particular parent target area. Additionally, in the above expression “s_{c}” may represent the sum of the weights “w_{c}.” Note that the area scoring formulas “A_{c}” of the child target areas may include one or more area scoring formulas 122 of their own child target areas, which may include one or more metric scoring formulas 120, as indicated above. Additionally or alternatively, the area scoring formulas “A_{c}” of the child target areas may include one or more metric scoring formulas 120 of target metrics designated for analysis with respect to the child target areas. Further, the parent area score may include one or more metric scoring formulas 120 that may be designated for analysis with respect to the parent target area, but not any of its respective child target areas.

As indicated above, an area score of an ancestor target area (“ancestor score”) may indicate a state of the ancestor target area. As such, the inclusion of multiple descendant scoring formulas in the ancestor scoring formula may provide that the ancestor score may also represent the state of the ancestor target area as a combination of the descendant target areas.

In some embodiments, the management module 110 may be configured to generate one or more node scoring formulas 124 for the nodes included in the hierarchal data 115. The node scoring formulas 124 may be configured to generate scores for the nodes (“node scores”) that may indicate states of the target areas or target metrics that may correspond to the nodes. The node scoring formulas 124 may be based on the area scoring formulas 122 and/or based on the metric scoring formulas 120. For example, the management module 110 may generate a node scoring formula 124 for each node from the area scoring formulas 122 or the metric scoring formulas 120 of the target areas or target metrics that correspond to the respective nodes. In some embodiments, a node scoring formula 124 may include the corresponding area scoring formula 122 or the corresponding metric scoring formula 120. Additionally or alternatively, a node scoring formula 124 may be substantially the same as the corresponding area scoring formula 122 or the corresponding metric scoring formula.

In some embodiments, the management module 110 may be configured to determine the node scores based on obtained data, the data map 114, and the node scoring formulas 124. For example, the management module 110 may identify subset data that may be included in data of a particular data type that may be designated for analysis with respect to a particular target area. For example, in some embodiments, the management module 110 may identify subset data of the particular data type that has been tagged with respect to the particular target area and the particular target metric according to the data map 114. Additionally or alternatively, one or more data fields of the data may be tagged with respect to the particular target area and the particular target metric according to the data map 114. In some embodiments, the management module 110 may obtain the data and may tag the subset data according to the data map 114. Additionally or alternatively, the subset data may have been tagged by a third-party according to the data map 114.

Based on the tagging of the data, the management module 110 may be configured to apply the tagged data to one or more scoring formulas 116 that may correspond to the particular target area and the particular target metric. For example, the management module 110 may be configured to apply the tagged data to a particular node scoring formula 124 of a particular node that corresponds to the particular target area and to a descendent node scoring formula 124 of a node that is a descendant node of the particular node. Additionally or alternatively, the management module 110 may be configured to apply the tagged data to area scoring formulas and/or target scoring formulas that may correspond to the particular target area. In some embodiments, the management module 110 may be configured to apply the tagged data to the applicable scoring formulas 116 by extracting, from the tagged data and based on the tagging, values that may be input into the applicable node scoring formulas 124.

In some embodiments, the management module 110 may be configured to generate a digital user interface dashboard (“dashboard”) based on the node scores and the data map. For example, the dashboard may be configured to provide a visualization of the node scores in relation to the target areas and/or target metrics that may correspond to the nodes associated with the node scores. Further, the dashboard may be configured to present the node scores in relation to their respective target areas or target metrics in a hierarchal manner based on tagging (e.g., according to the data map) of the data used to generate the node scores. Further, a hierarchal framework of the dashboard may be configured based on the hierarchal data 115 and the designation data 117, which may be included in the data map 114 in some embodiments. The hierarchal arrangement of the node scores may provide a representation of a state of an ancestor target area with respect to a combination of descendant target areas or target metrics while also providing a breakdown of one or more individual target areas or target metrics that may affect the state of the ancestor target area. In some embodiments, the dashboard may be provided to the organization device 106 such that it may be displayed via a user interface of the organization device 106.

Modifications, additions, or omissions may be made to FIG. 1 without departing from the scope of the present disclosure. For example, the separation and differentiation between different components of the environment 100 are merely for illustrative purposes. Further, although the management module 110 is illustrated as being included in the management server 108, the management module 110 may be included in or distributed between any suitable computing device or computing devices. For example, in some embodiments, the management module 110 may be distributed between the management server 108 and the organization device 106 such that one or more operations described with respect to the management module 110 may be performed at the organization device 106 and/or at the management server 108.

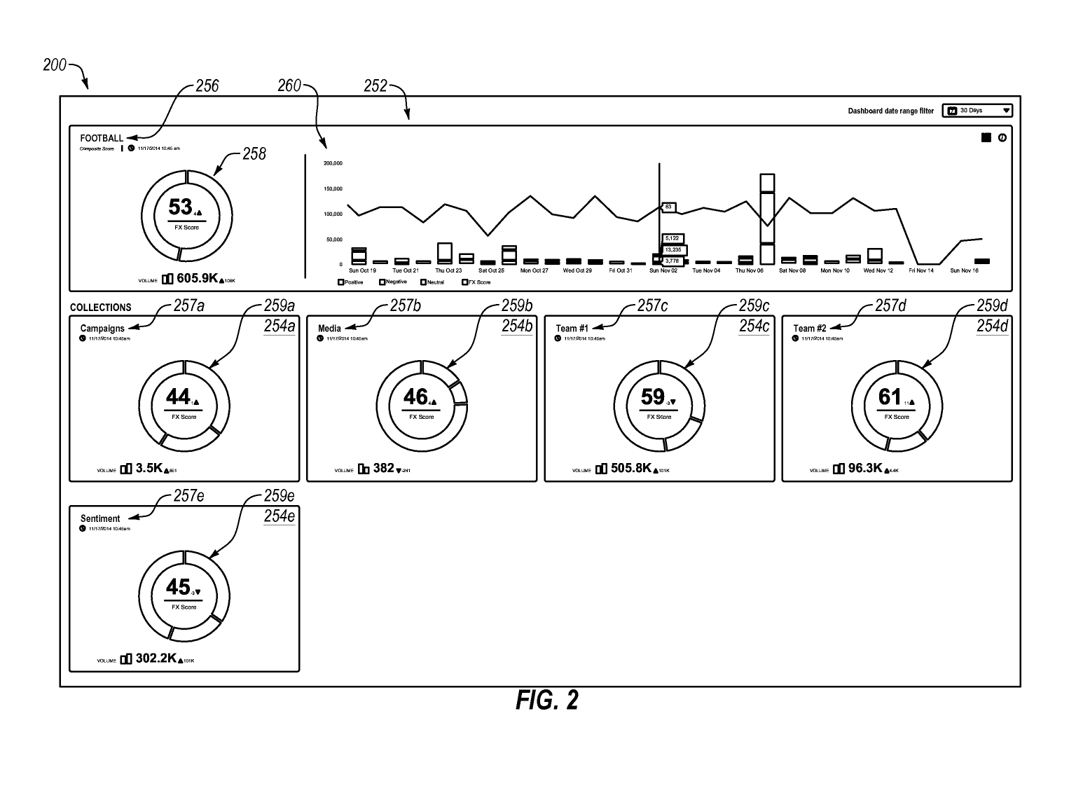

FIG. 2 illustrates an example digital user interface dashboard 200 (“dashboard 200”) that may provide a visualization of node scores associated with an organization in a hierarchal manner, according to at least one embodiment described in the present disclosure. The dashboard 200 may include a parent field 252 and one or more child fields 254.

The parent field 252 may be associated with a parent target area of the organization. The parent field 252 may include one or more fields that may represent a state of the parent target area.

The child fields 254 may each be associated with a child target area of the parent target area or a target metric that may be designated for analysis with respect to the parent field 252. In some embodiments, the child fields 254 may be determined from hierarchal data and/or designation data. In the illustrated example, the dashboard 250 may include a first child field 254a, a second child field 254b, a third child field 254c, a fourth child field 254d, and a fifth child area field 254e. However, the number of child fields 254 may vary depending on the number of child target areas and/or target metrics that may be associated with the parent target area.

The child fields 254 associated with child target areas of the parent target area may include fields that may represent a state of the corresponding child target area. The child fields 254 associated with target metrics designated for analysis with respect to the parent target area may include fields that may represent a state of the parent target area with respect to the corresponding target metrics.

In some embodiments, the parent field 252 may include an identification field 256, which may indicate the parent target area. For example, in the illustrated example of FIG. 1B, the identification field 256 may identify the parent target area as a football organization “Football.” Additionally, the parent field 252 may include a score field 258 that may represent a node score associated with the parent target area. In these or other embodiments, the parent field 252 may include a graph field 160 that may indicate changes in the node score of the score field 258 over a certain period of time.

The node score of the score field 258 may represent a state the parent target area and, as explained above, may also represent the state of the parent target area with respect to a combination of the child target areas and the target metrics that may be associated with the child fields 254. In the illustrated example, the parent target area may be the football organization as a whole such that the node score of the score field 258 may indicate an overall state of the football organization.

In some embodiments, the child fields 254 may each include an identification field 257, which may indicate the respective child target area or child target metric. For example, the child field 254a may include an identification field 257a that may identify “Campaigns,” which may be a child target area of the parent target area “Football.” The child field 254b may include an identification field 257b that may identify “Media,” which may be another child target area of the parent target area “Football.” The child field 254c may include an identification field 257c that may identify “Team #1,” which may be another child target area of the parent target area “Football.” The child field 254d may include an identification field 257d that may identify “Team #2,” which may be another child target area of the parent target area “Football.” Additionally, the child field 254e may include an identification field 257e that may identify “Sentiment,” which may be a target metric designated for analysis with respect to the parent target area “Football.”

The child fields 254 may also each include score fields 259 that may indicate scores that may be associated with their respective target areas or target fields. For example, the child field 254a may include a score field 259a that may indicate a score that may represent a state of the child target area “Campaigns.” The child field 254b may include a score field 259b that may indicate a score that may represent a state of the child target area “Media.” The child field 254c may include a score field 259c that may indicate a score that may represent a state of the child target area “Team #1.” The child field 254d may include a score field 259d that may indicate a score that may represent a state of the child target area “Team #2.” Additionally, the child field 254e may include a score field 259e that may indicate a score that may represent a state of the football organization with respect to the target metric “Sentiment.”

The child fields 254 may be configured with respect to the parent field 252 such that they may be identified as being associated with target areas and target metrics that have child hierarchal relationships with respect to the parent target area. For example, in the illustrated example, the parent field 252 may include additional fields (e.g., the graph field 160) as compared to the child fields 254 or may be bigger than the child fields 254 to differentiate it from the child fields and to indicate it is the parent field. As another example, the parent field 252 may be oriented at the top of the dashboard 250, with the child fields disposed beneath it. Any other differentiating factor may also be used to indicate the hierarchal relationships between the parent field 252 and the child fields 254.

The presentation of the parent field 252 may allow for a user to view a parent score that indicates an overall state of the corresponding parent target area. Further, the hierarchal presentation of the parent field 252 together with one or more child fields 254 may also provide a breakdown of what went into the parent score by indicating the scores of the target areas and target metrics that may be included in the parent score. Therefore the dashboard 250 may facilitate assessing and visualizing different states of an organization.

Modifications, additions, or omissions may be made to FIG. 2 without departing from the scope of the present disclosure. For example, the parent field 252 and/or the child fields 254 may be organized or configured in a different manner from that illustrated. Further, the number of child fields 254 may vary as described above. In addition, in some embodiments, the dashboard 250 may be configured to include more than one parent field 252 and their associated child fields 254. In addition, in some embodiments, the dashboard 250 may include child fields of the child fields 254 such that more than two hierarchal levels may be illustrated in the dashboard 250.

Furthermore, the dashboard 250 may be configured such that selecting a field (e.g., the identification field 257) of a child field 254 may cause the corresponding target area or target metric to be associated with the parent field 252. In these or other embodiments, the resulting child fields 254 may be associated with target areas and/or target metrics with child hierarchal relationships with respect to the corresponding target area or target metric.

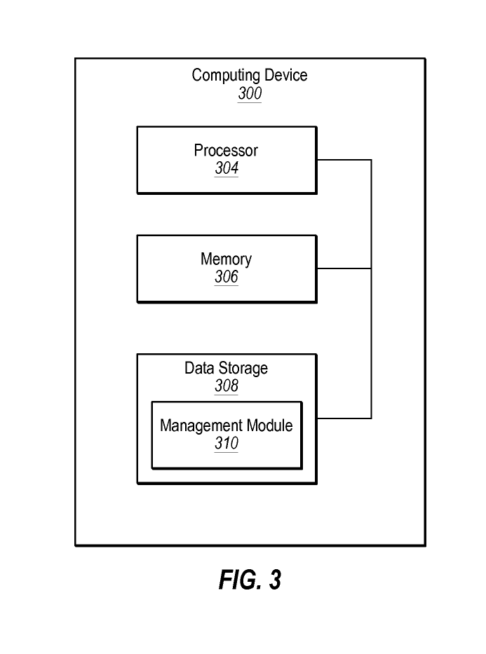

FIG. 3 illustrates an example computing device 300, arranged in accordance with at least one embodiment described in the present disclosure. The computing device 300 may be configured for data management. The computing device 300 may include one or more processors 304, memory 306, and data storage 308 that includes a management module 310. Some examples of the computing device 300 may include the management server 108 and the organization device 106, discussed elsewhere in the present disclosure. Accordingly, the management module 310 may include the management module 110 of FIG. 1, or some portions thereof may be configured to perform one or more operations variously attributed thereto.

The processor 304 may include any suitable special-purpose or general-purpose computer, computing entity, or processing device including various computer hardware or software modules and may be configured to execute instructions stored on any applicable computer-readable storage media. For example, the processor 304 may include a microprocessor, a microcontroller, a digital signal processor (DSP), an ASIC, a FPGA, or any other digital or analog circuitry configured to interpret and/or to execute program instructions and/or to process data. Although illustrated as a single processor in FIG. 3, it is understood that the processor 304 may include any number of processors configured to perform individually or collectively any number of operations described in the present disclosure. Additionally, one or more of the processors may be present on one or more different computing devices. In some embodiments, the processor 304 may interpret and/or execute program instructions and/or process data stored in the memory 306, the data storage 308, or the memory 306 and the data storage 308. In some embodiments, the processor 304 may fetch program instructions from the data storage 308 and load the program instructions in the memory 306. After the program instructions are loaded into memory 306, the processor 304 may execute the program instructions.

The memory 306 and data storage 308 may include computer-readable storage media for carrying or having computer-executable instructions or data structures stored thereon. Such computer-readable storage media may include any available media that may be accessed by a general-purpose or special-purpose computer, such as the processor 304. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 304 to perform a certain operation or group of operations.

The management module 310 may include program instructions stored in the data storage 308. The processor 304 may be configured to load the management module 310 into the memory 306 and execute the management module 310. When executing the management module 310, the processor 304 may be configured to perform operations of data management as described elsewhere in the present disclosure.

In view of this disclosure, it will be appreciated that modifications, additions, or omissions may be made to the computing device 300 without departing from the scope of the present disclosure. For example, in some embodiments, the different components of the computing device 300 may be physically separate or may be communicatively coupled via any suitable mechanism. For example, the data storage 308 may be part of a storage device that is separate from a server that may include the processor 304 and the memory 306.

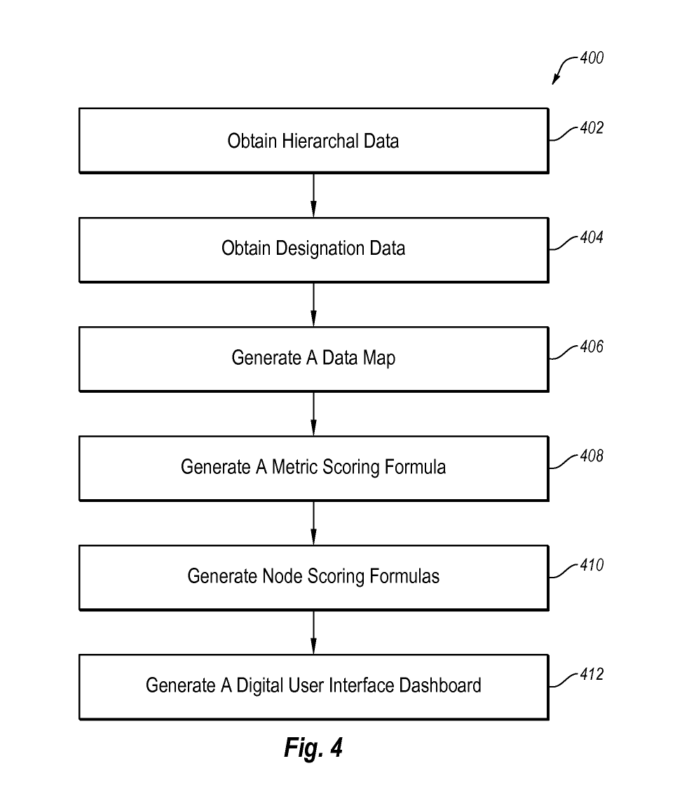

FIG. 4 illustrates an example method 400 for managing data, according to at least one embodiment described in the present disclosure. Although the operations of the method 400 are described in a specific order and manner, one or more of the operations of the method 400 may be performed in a different order than that explicitly described. Additionally, one or more operations may be performed concurrently. Moreover, one or more of the operations may include additional operations not expressly described or may have one or more described operations omitted. In some embodiments, one or more of the operations of the method 400 may be performed by a data management module, such as the management module 110 or the management module 310 of FIGS. 1 and 3, respectively.

The method 400 may begin and at a block 402, in which hierarchal data may be obtained. The hierarchal data may correspond to a hierarchy associated with an organization. The hierarchal data may indicate hierarchal relationships of nodes in the hierarchy that may correspond to target areas and/or target metrics of the organization. For example, the hierarchal data may indicate a first node of the hierarchy, a second node of the hierarchy, and a first hierarchal relationship in the hierarchy between the first node and the second node in which the first node is an ancestor node of the second node in the hierarchy. Additionally, the first node may correspond to a first target area of the organization and the second node may correspond to a second target area of the organization that is a subset of the first target area. Additionally or alternatively, the hierarchal data may indicate

At block 404, designation data may be obtained. The designation data may include data types, data fields, target metrics, target areas, etc. For example, the designation data may include one or more of the following: the first target area, the second target area, a data field that is designated for analysis with respect to the second target area; and a target metric that is indicated by data of the data type and that is designated for analysis with respect to the second target area. Additionally or alternatively, the designation data may include weights associated with the target areas.

At block 406, a data map may be generated based on the hierarchal data and the designation data. The data map may be analogous to the data map 114 described with respect to FIG. 1.

At block 408, metric scoring formulas may be generated based on the designation data. For example, a metric scoring formula may be generated for the target metric that is designated for analysis with respect to the second target area based on the designation data.

At block 410, one or more node scoring formulas may be generated, such as described above. The node scoring formulas may be configured to generate node scores that may indicate states of the target areas or target metrics that may correspond to the nodes of the node scoring formulas. As indicated above, in some embodiments, weights indicated in the designation data may be applied to the node scoring formulas.

For example, a second-node scoring formula may be generated for the second node and may be configured to generate a second-node score. The second-node score may indicate a state of the second target area. The second-node scoring formula may include the metric scoring formula based on the target metric being designated for analysis with respect to the second node, which may be indicated by the designation data. Additionally or alternatively, a weight associated with the target metric may be applied to the metric scoring formula included in the second-node scoring formula. As another example, a first-node scoring formula may be generated for the first node. The first-node scoring formula may indicate a state of the first target area. Additionally, the first-node scoring formula may include the second-node scoring formula based on the first hierarchal relationship, which may be indicated by the hierarchal data. Additionally or alternatively, a weight associated with the second target area may be applied to the second-node scoring formula included in the first-node scoring formula in some embodiments.

At block 412, a digital user interface dashboard (“dashboard”) may be generated. The dashboard may be generated based on one or more of the following: the data map, the hierarchal data, and the designation data. The dashboard may be configured to present node scores in relation to the target areas or target metrics of their respective nodes. Additionally, the dashboard may be configured to present the node scores in relation to each other to indicate the hierarchal relationships with respect to their respective target areas or target metrics.

For example, the dashboard may be configured to present the second-node score in relation to the second target area as indicated by the data map and to present the first-node score in relation to the first target area as indicated by the data map. Additionally, the dashboard may be configured to present the first-node score and the second-node score with respect to each other in a hierarchal manner according to the first hierarchal relationship.

Therefore, the method 400 may perform data management and processing in a manner that may allow for assessing one or more target areas of an organization. In some embodiments, the operations described with respect to the method 400 may be implemented in differing order. Furthermore, the outlined steps and actions are only provided as examples, and some of the operations may be optional, combined into fewer operations, or expanded into additional operations without detracting from the essence of the disclosed embodiment.

For example, in some embodiments, the method 400 may further include operations related to identifying subset data in the data of the data type that is designated for analysis with respect to the second target area. Additionally or alternatively, the method 400 may include generating the metric score based on the metric scoring formula and the subset data. In these or other embodiments, the method 400 may include generating the second-node score based on the second-node scoring formula and the subset data. Additionally, the method 400 may include generating the first-node score based on the first-node scoring formula and the subset data.

Additionally, in some embodiments, the hierarchal data may indicate and/or be modified to indicate nodes not expressly given as examples. Further, the designation data may include indications related to other target areas, data types, data types, and/or target metrics not expressly given as examples. Additionally or alternatively, other scoring formulas may be generated with respect to the other nodes and their associated target metrics or target areas. Moreover, the dashboard may be configured to present different node scores and their hierarchal relationships than expressly given as examples.

Below are examples that are extensions of the examples given above with respect to the first node, the first target area, the second node, the second target area, the data type designated for analysis with respect to the second target area, and the target metric that is indicated by data of the data type and that is designated for analysis with respect to the second target area. The examples given below are meant to illustrate example operations that may be performed with respect to the method 400.

### EXAMPLE 1

In some embodiments, the method 400 may include one or more operations related to modifying the hierarchal data to indicate a third node that corresponds to the target metric. The method 400 may further include operations related to determining, based on the target metric being designated for analysis with respect to the second target area, a second hierarchal relationship in the hierarchy between the second node and the third node in which the second node is an ancestor node of the third node. Also, the method 400 may include operations related to modifying the hierarchal data to indicate the second hierarchal relationship in the hierarchy between the second node and the third node.

Further, the method 400 may include operations related to generating a third-node scoring formula that includes the metric scoring formula and that determines a third-node score for the third node and generating the second-node scoring formula to include the third-node scoring formula.

Further, the method 400 may include operations related to configuring the digital user interface dashboard to present the third node score in relation to the target metric. The third-node score may be presented with respect to the first-node score and the second-node score in the hierarchal manner according to the first hierarchal relationship and the second hierarchal relationship, which may be indicated in the hierarchal data.

### EXAMPLE 2

As another example, the hierarchal data may indicate a third node of the hierarchy and a second hierarchal relationship in the hierarchy in which the first node is an ancestor node of the third node and the second node is a sibling node of the third node. The third node may correspond to a third target area of the organization that is another subset of the first target area and the target metric may be further designated for analysis with respect to the third target area.

Additionally or alternatively, the method 400 may further include generating, a third-node scoring formula that includes the metric scoring formula and that determines a third-node score for the third node. The third-node scoring formula may include the metric scoring formula based on the target metric being further designated for analysis with respect to the third target area, which may be indicated by the designation data. The method 400 may also include generating the first-node scoring formula to further include the third-node scoring formula based on the second hierarchal relationship, which may be indicated by the hierarchal data. Additionally or alternatively, the method 400 may include obtaining a weight associated with the third-target area with respect to the first target area and applying the weight to the third-node scoring formula included in the first-node scoring formula.

Moreover, the method 400 may include configuring the digital user interface dashboard to present the third-node score in relation to the third node. The third-node score may be presented with respect to the first-node score and the second-node score in the hierarchal manner according to the first hierarchal relationship and the second hierarchal relationship, which may be indicated in the hierarchal data.

### EXAMPLE 3

As another example, in some embodiments, the hierarchal data may indicate a third node of the hierarchy and a second hierarchal relationship in the hierarchy in which the first node is an ancestor node of the third node and the second node is a sibling node of the third node. The third node may correspond to a third target area of the organization that is another subset of the first target area. Additionally, the metric scoring formula for the target metric that is designated for analysis with respect to the second target area may be a first metric scoring formula and the target metric that is designated for analysis with respect to the second target area may be a first target metric. Moreover, the data of the data type that is designated for analysis with respect to the second target area may be first data and the data type that is designated for analysis with respect to the second target area may be a first data type.

In these or other embodiments, the method 400 may further include obtaining a second data type that is designated for analysis with respect to the third target area. Additionally, the method 400 may include identifying a second target metric that is indicated by second data of the second data type and that is designated for analysis with respect to the third target area.

Moreover, the method 400 may include generating a second metric scoring formula for the second target metric and generating a third-node scoring formula that includes the second metric scoring formula and that determines a third-node score for the third node. The third-node scoring formula may include the second metric scoring formula based on the second target metric being designated for analysis with respect to the third target area. Further, the method 400 may include generating the first-node scoring formula to further include the third-node scoring formula based on the second hierarchal relationship. Additionally or alternatively, the method 400 may include obtaining a weight associated with the third-target area with respect to the first target area and applying the weight to the third-node scoring formula included in the first-node scoring formula.

The method 400 may also include configuring the digital user interface dashboard to present the third-node score in relation to the third node. The third-node score may be presented with respect to the first-node score and the second-node score in the hierarchal manner according to the first hierarchal relationship and the second hierarchal relationship indicated in the hierarchal data.

### EXAMPLE 4

As another example, in some embodiments, the hierarchy associated with the organization may be an overall hierarchy. Additionally, the hierarchal data may indicate a third node that corresponds to a first subset of data of the data type that is at a first data level of a data hierarchy of the data.

The method 400 may also include one or more operations related to determining (e.g., based on the data type of the data being designated for analysis with respect to the second target area), a second hierarchal relationship in the overall hierarchy between the second node and the third node in which the second node may be an ancestor node of the third node. The method 400 may also include modifying the hierarchal data to indicate a fourth node that corresponds to a second subset of the data at a second data level of the data hierarchy. The second data level may be a sublevel of the first data level.

The method 400 may also include determining (e.g., based on the second data level being a sublevel of the first data level) a third hierarchal relationship in the overall hierarchy between the third node and the fourth node in which the third node is an ancestor node of the fourth node. Further, the method 400 may include modifying the hierarchal data to indicate the second hierarchal relationship and the third hierarchal relationship.

Additionally or alternatively, the method 400 may include generating a fourth-node scoring formula that includes the metric scoring formula and that determines a fourth-node score for the fourth node. The method 400 may further include generating a third-node scoring formula that includes the fourth-node scoring formula. The third-node scoring formula may determine a third-node score for the third node. Additionally, the third-node scoring formula may include the fourth-node scoring formula based on the second data level being a sublevel of the first data level. Moreover, the method 400 may include generating the second-node scoring formula to include the third-node scoring formula based on the data type of the data being designated for analysis with respect to the second target area.

In these or other embodiments, the method 400 may include configuring the digital user interface dashboard to include the fourth-node score in relation to the second subset of the data and the third-node score in relation to the first subset of the data. The fourth-node score and the third-node score may be presented with respect to each other and with respect to the first-node score and the second-node score in the hierarchal manner according to the first hierarchal relationship, the second hierarchal relationship, and the third hierarchal relationship, which may be indicated in the hierarchal data.

As indicated above, the embodiments described in the present disclosure may include the use of a special purpose or general purpose computer (e.g., the processor 304 of FIG. 3) including various computer hardware or software modules, as discussed in greater detail below. Further, as indicated above, embodiments described in the present disclosure may be implemented using computer-readable media (e.g., the memory 306 and/or the data storage 308 of FIG. 3) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail various changes, substitutions, and alterations could be made hereto without departing from the spirit and scope of the present disclosure.

What is claimed is:

1. A method comprising:
obtaining hierarchal data corresponding to a hierarchy associated with an organization, the hierarchal data indicating a first node of the hierarchy, a second node of the hierarchy, and a first hierarchal relationship in the hierarchy between the first node and the second node in which the first node is an ancestor node of the second node in the hierarchy, wherein the first node corresponds to a first target area of the organization and the second node corresponds to a second target area of the organization that is a subset of the first target area;
obtaining designation data that includes:
a data type that is designated for analysis with respect to the second target area; and
a target metric that is indicated by data of the data type and that is designated for analysis with respect to the second target area;
generating a data map based on the hierarchal data and the designation data;
generating a metric scoring formula for the target metric based on the designation data;
generating a second-node scoring formula that includes the metric scoring formula and that determines a second-node score for the second node, wherein the second-node scoring formula includes the metric scoring formula based on the target metric being designated for analysis with respect to the second target area, as indicated by the designation data;
generating a first-node scoring formula that includes the second-node scoring formula and that generates a first-node score for the first node, wherein the first-node scoring formula includes the second-node scoring formula based on the first hierarchal relationship, as indicated by the hierarchal data; and
generating a digital user interface dashboard based on one or more of the following: the data map, the hierarchal data, and the designation data, wherein the digital user interface dashboard is configured to present the second-node score in relation to the second target area as indicated by the data map, present the first-node score in relation to the first target area as indicated by the data map, and present the first-node score and the second-node score with respect to each other in a hierarchal manner according to the first hierarchal relationship.

2. The method of claim 1, further comprising:
modifying the hierarchal data to indicate a third node that corresponds to the target metric;
determining, based on the target metric being designated for analysis with respect to the second target area, a second hierarchal relationship in the hierarchy between the second node and the third node in which the second node is an ancestor node of the third node;
modifying the hierarchal data to indicate the second hierarchal relationship in the hierarchy between the second node and the third node;
generating a third-node scoring formula that includes the metric scoring formula and that determines a third-node score for the third node;
generating the second-node scoring formula to include the third-node scoring formula; and
configuring the digital user interface dashboard to present the third node score in relation to the target metric, wherein the third-node score is presented with respect to the first-node score and the second-node score in the hierarchal manner according to the first hierarchal relationship and the second hierarchal relationship.

3. The method of claim 1, further comprising:
identifying subset data in the data of the data type that is designated for analysis with respect to the second target area;
generating a metric score based on the metric scoring formula and the subset data;
generating the second-node score based on the second-node scoring formula and the subset data; and
generating the first-node score based on the first-node scoring formula and the subset data.

4. The method of claim 1, wherein:
the hierarchal data indicates a third node of the hierarchy and a second hierarchal relationship in the hierarchy in which the first node is an ancestor node of the third node and the second node is a sibling node of the third node;
the third node corresponds to a third target area of the organization that is another subset of the first target area;
the target metric is further designated for analysis with respect to the third target area; and
the method further comprises:
generating, a third-node scoring formula that includes the metric scoring formula and that determines a third-node score for the third node; wherein the third-node scoring formula includes the metric scoring formula based on the target metric being further designated for analysis with respect to the third target area, as indicated by the designation data;
generating the first-node scoring formula to further include the third-node scoring formula based on the second hierarchal relationship, as indicated by the hierarchal data; and
configuring the digital user interface dashboard to present the third-node score in relation to the third node, wherein the third-node score is presented with respect to the first-node score and the second-node score in the hierarchal manner according to the first hierarchal relationship and the second hierarchal relationship indicated in the hierarchal data.

5. The method of claim 4, further comprising:
obtaining a first weight associated with the second target area;
obtaining a second weight associated with the third target area;
applying the first weight to the second-node scoring formula in the first node-scoring formula; and
applying the second weight to the third-node scoring formula in the first node-scoring formula.

6. The method of claim 1, wherein:
the hierarchal data indicates a third node of the hierarchy and a second hierarchal relationship in the hierarchy in which the first node is an ancestor node of the third node and the second node is a sibling node of the third node;
the third node corresponds to a third target area of the organization that is another subset of the first target area;
the metric scoring formula for the target metric that is designated for analysis with respect to the second target area is a first metric scoring formula;
the target metric that is designated for analysis with respect to the second target area is a first target metric;
the data of the data type that is designated for analysis with respect to the second target area is first data;
the data type that is designated for analysis with respect to the second target area is a first data type; and
the method further comprises:
obtaining a second data type that is designated for analysis with respect to the third target area;
identifying a second target metric that is indicated by second data of the second data type and that is designated for analysis with respect to the third target area;
generating a second metric scoring formula for the second target metric;
generating a third-node scoring formula that includes the second metric scoring formula and that determines a third-node score for the third node; wherein the third-node scoring formula includes the second metric scoring formula based on the second target metric being designated for analysis with respect to the third target area;
generating the first-node scoring formula to further include the third-node scoring formula based on the second hierarchal relationship; and
configuring the digital user interface dashboard to present the third-node score in relation to the third node, wherein the third-node score is presented with respect to the first-node score and the second-node score in the hierarchal manner according to the first hierarchal relationship and the second hierarchal relationship indicated in the hierarchal data.

7. The method of claim 6, further comprising:
obtaining a first weight associated with the second target area;
obtaining a second weight associated with the third target area;
applying the first weight to the second-node scoring formula in the first node-scoring formula; and
applying the second weight to the third-node scoring formula in the first node-scoring formula.

8. The method of claim 1, wherein the hierarchy associated with the organization is an overall hierarchy, the hierarchal data indicates a third node that corresponds to a first subset of data of the data type that is at a first data level of a data hierarchy of the data; and wherein the method further comprises:
determining, based on the data type of the data being designated for analysis with respect to the second target area, a second hierarchal relationship in the overall hierarchy between the second node and the third node in which the second node is an ancestor node of the third node;
modifying the hierarchal data to indicate a fourth node that corresponds to a second subset of the data at a second data level of the data hierarchy that is a sublevel of the first data level;
determining, based on the second data level being a sublevel of the first data level, a third hierarchal relationship in the overall hierarchy between the third node and the fourth node in which the third node is an ancestor node of the fourth node; and
modifying the hierarchal data to indicate the second hierarchal relationship and the third hierarchal relationship.

9. The method of claim 8, further comprising:
generating a fourth-node scoring formula that includes the metric scoring formula and that determines a fourth-node score for the fourth node;
generating a third-node scoring formula that includes the fourth-node scoring formula and that determines a third-node score for the third node, wherein the third-node scoring formula includes the fourth-node scoring formula based on the second data level being a sublevel of the first data level;
generating the second-node scoring formula to include the third-node scoring formula based on the data type of the data being designated for analysis with respect to the second target area; and
configuring the digital user interface dashboard to include the fourth-node score in relation to the second subset of the data and the third-node score in relation to the first subset of the data, wherein the fourth-node score and the third-node score are presented with respect to each other and with respect to the first-node score and the second-node score in the hierarchal manner according to the first hierarchal relationship, the second hierarchal relationship, and the third hierarchal relationship, indicated in the hierarchal data.

10. The method of claim 1, further comprising:
obtaining a weight for the target metric; and
applying the weight to the metric scoring formula in the second-node scoring formula.

11. The method of claim 1, further comprising:
obtaining a weight for the second target area; and
applying the weight to the second-node scoring formula in the first-node scoring formula.

12. Computer-readable storage media including computer-executable instructions configured to cause a system to perform operations, the operations comprising:
obtaining hierarchal data corresponding to a hierarchy associated with an organization, the hierarchal data indicating a first node of the hierarchy, a second node of the hierarchy, and a first hierarchal relationship in the hierarchy between the first node and the second node in which the first node is an ancestor node of the second node in the hierarchy, wherein the first node corresponds to a first target area of the organization and the second node corresponds to a second target area of the organization that is a subset of the first target area;
obtaining designation data that includes:
a data type that is designated for analysis with respect to the second target area; and
a target metric that is indicated by data of the data type and that is designated for analysis with respect to the second target area;
generating a data map based on the hierarchal data and the designation data;
generating a metric scoring formula for the target metric based on the designation data;
generating a second-node scoring formula that includes the metric scoring formula and that determines a second-node score for the second node, wherein the second-node scoring formula includes the metric scoring formula based on the target metric being designated for analysis with respect to the second target area, as indicated by the designation data;
generating a first-node scoring formula that includes the second-node scoring formula and that generates a first-node score for the first node, wherein the first-node scoring formula includes the second-node scoring formula based on the first hierarchal relationship, as indicated by the hierarchal data; and
generating a digital user interface dashboard based on one or more of the following: the data map, the hierarchal data, and the designation data, wherein the digital user interface dashboard is configured to present the second-node score in relation to the second target area as indicated by the data map, present the first-node score in relation to the first target area as indicated by the data map, and present the first-node score and the second-node score with respect to each other in a hierarchal manner according to the first hierarchal relationship.

13. The computer-readable storage media of claim 12, wherein the operations further comprise:
modifying the hierarchal data to indicate a third node that corresponds to the target metric;
determining, based on the target metric being designated for analysis with respect to the second target area, a second hierarchal relationship in the hierarchy between the second node and the third node in which the second node is an ancestor node of the third node;
modifying the hierarchal data to indicate the second hierarchal relationship in the hierarchy between the second node and the third node;
generating a third-node scoring formula that includes the metric scoring formula and that determines a third-node score for the third node;
generating the second-node scoring formula to include the third-node scoring formula; and
configuring the digital user interface dashboard to present the third node score in relation to the target metric, wherein the third-node score is presented with respect to the first-node score and the second-node score in the hierarchal manner according to the first hierarchal relationship and the second hierarchal relationship.

14. The computer-readable storage media of claim 12, wherein the operations further comprise:
identifying subset data in the data of the data type that is designated for analysis with respect to the second target area;
generating a metric score based on the metric scoring formula and the subset data;
generating the second-node score based on the second-node scoring formula and the subset data; and
generating the first-node score based on the first-node scoring formula and the subset data.

15. The computer-readable storage media of claim 12, wherein:
the hierarchal data indicates a third node of the hierarchy and a second hierarchal relationship in the hierarchy in which the first node is an ancestor node of the third node and the second node is a sibling node of the third node;
the third node corresponds to a third target area of the organization that is another subset of the first target area;
the target metric is further designated for analysis with respect to the third target area; and
the operations further comprise:
generating, a third-node scoring formula that includes the metric scoring formula and that determines a third-node score for the third node; wherein the third-node scoring formula includes the metric scoring formula based on the target metric being further designated for analysis with respect to the third target area, as indicated by the designation data;
generating the first-node scoring formula to further include the third-node scoring formula based on the second hierarchal relationship, as indicated by the hierarchal data; and
configuring the digital user interface dashboard to present the third-node score in relation to the third node, wherein the third-node score is presented with respect to the first-node score and the second-node score in the hierarchal manner according to the first hierarchal relationship and the second hierarchal relationship indicated in the hierarchal data.

16. The computer-readable storage media of claim 15, wherein the operations further comprise:
obtaining a first weight associated with the second target area;
obtaining a second weight associated with the third target area;
applying the first weight to the second-node scoring formula in the first node-scoring formula; and
applying the second weight to the third-node scoring formula in the first node-scoring formula.

17. The computer-readable storage media of claim 12, wherein:
the hierarchal data indicates a third node of the hierarchy and a second hierarchal relationship in the hierarchy in which the first node is an ancestor node of the third node and the second node is a sibling node of the third node;
the third node corresponds to a third target area of the organization that is another subset of the first target area;
the metric scoring formula for the target metric that is designated for analysis with respect to the second target area is a first metric scoring formula;
the target metric that is designated for analysis with respect to the second target area is a first target metric;
the data of the data type that is designated for analysis with respect to the second target area is first data;
the data type that is designated for analysis with respect to the second target area is a first data type; and
the operations further comprise:
obtaining a second data type that is designated for analysis with respect to the third target area;
identifying a second target metric that is indicated by second data of the second data type and that is designated for analysis with respect to the third target area;
generating a second metric scoring formula for the second target metric;
generating a third-node scoring formula that includes the second metric scoring formula and that determines a third-node score for the third node; wherein the third-node scoring formula includes the second metric scoring formula based on the second target metric being designated for analysis with respect to the third target area;
generating the first-node scoring formula to further include the third-node scoring formula based on the second hierarchal relationship; and
configuring the digital user interface dashboard to present the third-node score in relation to the third node, wherein the third-node score is presented with respect to the first-node score and the second-node score in the hierarchal manner according to the first hierarchal relationship and the second hierarchal relationship indicated in the hierarchal data.

18. The computer-readable storage media of claim 17, wherein the operations further comprise:
obtaining a first weight associated with the second target area;
obtaining a second weight associated with the third target area;
applying the first weight to the second-node scoring formula in the first node-scoring formula; and
applying the second weight to the third-node scoring formula in the first node-scoring formula.

19. The computer-readable storage media of claim 12, wherein the hierarchy associated with the organization is an overall hierarchy, the hierarchal data indicates a third node that corresponds to a first subset of data of the data type that is at a first data level of a data hierarchy of the data; and wherein the operations further comprise:
determining, based on the data type of the data being designated for analysis with respect to the second target area, a second hierarchal relationship in the overall hierarchy between the second node and the third node in which the second node is an ancestor node of the third node;
modifying the hierarchal data to indicate a fourth node that corresponds to a second subset of the data at a second data level of the data hierarchy that is a sublevel of the first data level;
determining, based on the second data level being a sublevel of the first data level, a third hierarchal relationship in the overall hierarchy between the third node and the fourth node in which the third node is an ancestor node of the fourth node; and
modifying the hierarchal data to indicate the second hierarchal relationship and the third hierarchal relationship.

20. The computer-readable storage media of claim 19, wherein the operations further comprise:
generating a fourth-node scoring formula that includes the metric scoring formula and that determines a fourth-node score for the fourth node;
generating a third-node scoring formula that includes the fourth-node scoring formula and that determines a third-node score for the third node, wherein the third-node scoring formula includes the fourth-node scoring formula based on the second data level being a sublevel of the first data level;
generating the second-node scoring formula to include the third-node scoring formula based on the data type of the data being designated for analysis with respect to the second target area; and
configuring the digital user interface dashboard to include the fourth-node score in relation to the second subset of the data and the third-node score in relation to the first subset of the data, wherein the fourth-node score and the third-node score are presented with respect to each other and with respect to the first-node score and the second-node score in the hierarchal manner according to the first hierarchal relationship, the second hierarchal relationship, and the third hierarchal relationship, indicated in the hierarchal data.
